(19) United States
(12) Patent Application Publication
(10) Pub. No.: US 2002/0190020 A1
(43) Pub. Date: Dec. 19, 2002

(54) Baby bottle cap

(76) Inventor: Tami L. Noyd, Kings Beach, CA (US)

Correspondence Address: Herbert C. Schulze, PMB36, 2790 Wrondel Way, Reno, NV, 89502, US

(21) Appl. No.: 10/215,057

(22) Filed: Aug. 7, 2002

Related U.S. Application Data
(63) Continuation-in-part of application No. 09/782,588, filed on Feb. 12, 2001.

(51) Int. Cl. A61J 9/00; A61J 11/00

(52) U.S. Cl. 215/11.1

(57) ABSTRACT

This is an apparatus and method whereby customary fluid bottles can be safely used and adapted to nipples for use by babies and the like. The apparatus is primarily intended for, but not limited to, use on the widely used disposable bottles having 28 mm bottle necks.

The apparatus and method is also applicable to other types of fluid bottles and containers having necks or other fluid dispensing means.

### CROSS REFERENCE TO RELATED PATENT APPLICATIONS

The present invention is a continuation in part of my co-pending application for Universal Baby Bottle Cap, U.S. Ser. No. 09/782,588, filed Feb. 26, 2001 now ______.

### BACKGROUND OF THE INVENTION

I. Field of the Invention

This invention is in the general field of drinking devices;

The invention is more particularly in the fields of Cap/Closure Packaging and Baby Bottle Nipple systems.

The invention is even most particularly in the field of an improved, novel and useful one-piece cap and nipple that fits most disposable water and soda bottles with standard 28 mm bottle necks and which may incorporate safety, informational, and advertising features. I mention the 28 mm size because of its popularity and disposability. Any size and type bottle neck or dispensing orifice will be adaptable to my invention as described below. This will be a mere matter of choice to form a fluid-tight connection from a nipple to a bottle interior.

II Description of the Prior Art

I have conducted a thorough search of the field including patents, literature, and available commercial products. I have not found anything which encompasses or suggests the innovations and unique features of the total invention as described and illustrated herein.

Particularly, there is no prior art known to me utilizing a cap's rim as a marketing platform and/or a teething surface which also functions as a safety measure to prevent choking by being swallowed by an infant.

The most pertinent prior art known to me is the Gerber All In One, one-piece Nipple and Collar assembly, Gerber product # 1500078223, 1500078224, 1500078225, 1500078226, 1500078227, and 1500078228. The different Gerber product numbers refer to the various available packages, i.e. the number of units in a package, fashion colors or clear, and/or different flow rates. My invention differs in that the Gerber products fit only standard baby bottles, while my invention adapts to the many different 28 mm bottles and others available on the market.

I am also aware of United States Patents Numbers: In my searching I did discover inventions which are patented and which incorporate a feature of my invention. That feature is the incorporation of a nipple with a bottle cap so that an infant can take fluids from a common commercial bottle such as soft drinks, water, and the like. The patents I found are U.S. Pat. Nos. 5,678,710; 6,354,449 B1; 5,024,341; and United States Design Pat. No. US D459,815 S. Those patents cannot accomplish, nor suggest the features and purposes of my present invention, nor does anything else which I have found. While the mentioned patents combine the features of a nipple attached to a bottle cap adapter, they have not properly addressed nor suggested the safety features of my invention, nor the informational and advertising and other features.

### BRIEF DESCRIPTION OF THE DRAWINGS

FIG. 1 is a schematic perspective of a preferred embodiment of a nipple/bottle cap adapter in place on a broken away bottle and incorporating the unique, novel, and useful features of this invention; and

FIG. 2 is a schematic perspective of the adapter of FIG. 1 from the underside and removed from the bottle.

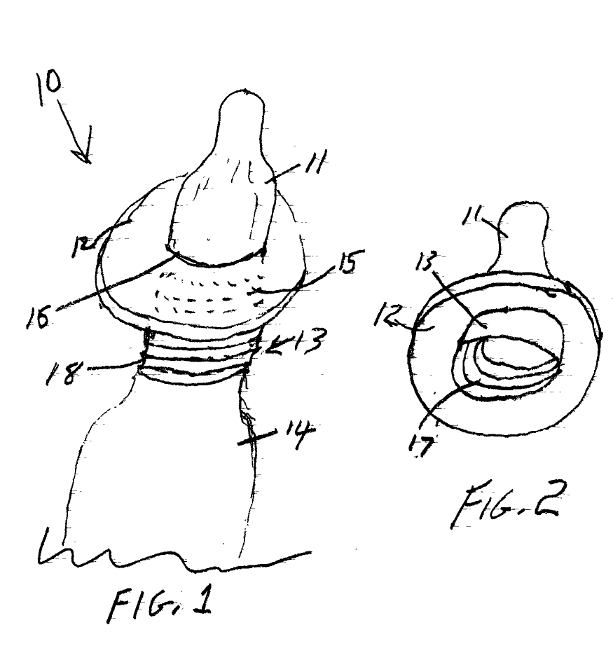

### DESCRIPTION OF A PREFERRED EMBODIMENT

An inventory of items in the drawings with reference numerals is:

Numeral Item

10 the adapter generally

11 nipple

12 adapter collar

13 bottle cap

14 bottle

15 advertising material

16 nipple base

17 interior threads on cap

18 cap exterior reflecting interior threads

nipple/bottle cap generally 10 comprises a customary nipple 11 such as a Gerber All Purpose Nipple, or any other nipple. An enlarged collar 12 is attached to, or formed integrally with the nipple at its base 16. A bottle cap 13 is integrally formed with, or attached to, the collar in such manner as to be in alignment with the nipple for proper fluid flow. The bottle cap can be of any desired type. Generally a cap to screw onto the bottle 14 utilizing customary internal threads 17 will be preferred. The threads 17 will normally be reflected on the exterior 18 of the cap, depending upon the manufacturing technique employed.

It must be understood that various manufacturing processes may be employed to construct this device. Also, various materials may be used as will be understood by those skilled in the art. It is also important to mention that it will be possible to use a snap on, or other hermetically sealable cap portion, rather than the threaded connection, as will be understood by those skilled in the art.

In understanding this invention fully it must be understood that I targeted it toward a young consumer. Therefore, the collar is of utmost importance. This element is a key to the success of my device and method.

The collar 12 may be of any size and dimension keeping in mind that the primary purpose is to prevent swallowing and choking. With that in mind the size must be such as to be incapable of fully entering a child's mouth. Additionally, the collar should be formed of a material which will be suitable for a child to chew upon to aid during teething.

An important use of the collar will be to allow imprinting of advertising material 15 or the like upon the collar.

The collar may be in many forms which can be used for the entertainment and visual pleasure of users. For example the collar need not be circular as shown, but may take the form of a leaf, a petal, a miniature pie, or the like. For teething purposes a texture such as a waffle or the like may be employed.

By this reference I hereby incorporate the contents of the claims and the abstract which follow into this description the same as though fully set forth again.

In the claims which follow if I should fail to claim any patentable feature such failure to claim will be inadvertent and is not to be interpreted as an abandonment or dedication of such feature. In such event, upon discovering the failure to claim I shall immediately seek to correct it by any proper means.

While the embodiment shown and described is fully capable of achieving the objects and advantages desired, it is to be understood that such embodiment has been shown for purposes of demonstration only and not for purposes of limitation.

I claim:

1. The method of dispensing fluid from a bottle for use through a nipple comprising:
associating an enlarged collar upon a bottle accepting opening in an otherwise customary nipple;
and associating a bottle opening connector with said collar in fluid passing alignment with said nipple.

2. The method of claim 1 wherein the bottle opening connector includes threads suitable to screw upon a threaded bottle neck.

3. An adapter to permit safe attachment and use of a nipple to a bottle comprising: an enlarged member which cannot fully enter a child's mouth in cooperative combination with a nipple and a fluid passing bottle cap.

4. The adapter of claim 3 wherein the enlarged member is suitable to be used as a teething device.

5. The adapter of claim 3 wherein the enlarged member carries advertising material.
